(19) United States
(12) Patent Application Publication
(10) Pub. No.: US 2015/0233755 A1
(43) Pub. Date: Aug. 20, 2015

(54) In-Motion Weighing System

(71) Applicant: LTS SCALE COMPANY, LLC, Twinsburg, OH (US)

(72) Inventor: Robert Thomas Pangrazio, Hudson, OH (US)

(73) Assignee: LTS SCALE COMPANY, LLC, Twinsburg, OH (US)

(21) Appl. No.: 14/626,151

(22) Filed: Feb. 19, 2015

Related U.S. Application Data
(60) Provisional application No. 61/941,564, filed on Feb. 19, 2014.

(51) Int. Cl. G01G 19/08

(52) U.S. Cl. CPC G01G 19/083

(57) ABSTRACT

A weighing apparatus and method enable an object to be weighed while the object and/or the weighing apparatus is in motion. The apparatus and method employ a load cell and an accelerometer that are both mounted on a platform upon which the object is situated. A signal from the load cell and a signal from the accelerometer are combined together to derive a mass of the load. Such combining of the signals may occur via signal processing that may include digital processing and/or analog processing. The load cell and the accelerometer each have an operative direction, and they may be oriented with respect to one another on the platform such that the operative directions are opposite one another to enable the two signals to be input to an analog multiplication circuit to derive a weight of the object.

### CROSS-REFERENCE TO RELATED APPLICATION

The instant application claims priority from U.S. Provisional Patent Application Ser. No. 61/941,564 filed Feb. 19, 2014, the disclosures of which are incorporated herein by reference.

### BACKGROUND

1. Field

The disclosed and claimed concept relates generally to weighing devices and, more particularly, to a weighing apparatus that can determine the mass of an object while the weighing apparatus and/or the object are in motion.

2. Related Art

As is generally understood in the relevant art, many weighing systems are configured to determine and/or output the mass of an object by measuring the weight of the object. The weight is a force that results from acceleration due to gravity being applied to the mass. For instance, an object having a mass of one kilogram in the presence of acceleration due to gravity (which is 9.81 meters per second squared) will exert a force of 9.81 Newtons on, for example, a scale if the object is placed thereon. When an item is to be weighed, it is placed upon a scale and if, for instance, the scale detects a load of 9.81 Newtons, the scale determines that the mass of the load is one kilogram.

Scales typically rely upon the force exerted by an object (i.e., due to gravitational acceleration) in determining the mass of an object because the force is typically usable either to deflect something (such as a spring or a piezoelectric crystal) in a known fashion or to counter-balance another known force (such as in the case of a balance-type scale that may employ one or more known weights that are applied at a fixed distance from a fulcrum or at varying distances from a fulcrum). Since the scales rely upon the force applied by an object due to acceleration from gravity, such scales have heretofore required that the load be static, meaning that the object must be stationary during the weighing operation. That is, the object typically cannot experience any acceleration in the vertical direction other than acceleration due to gravity since such acceleration would alter the force that is applied to the scale (which would cause the scale to output an erroneous mass for the object).

While the requirement that the load be static during weighing has typically not been problematic, it has become burdensome in situations where objects, in addition to being weighed, must also be moved from one location to another. While transport devices such as forklifts, and the like have been configured to include a scale that can determine the mass of a load carried on its platform, such forklifts and other devices have nevertheless been required to stop during the weighing operation in order to obtain an accurate weight for the object. Such stopping is undesirable because it delays the transportation of the object and other such objects to their desired destination. Such stopping may include not only ceasing movement of the transport device, but it may also include switching off any engine that may be operating on the transport device since the vibrations from an operating engine can sometimes vibrate and thus accelerate the object and/or the transport device in a fashion that can interfere with accurate measurement of the object. Improvement thus would be desirable.

### SUMMARY

An improved weighing apparatus and method enable an object to be weighed while the object and/or the weighing apparatus is in motion. The apparatus and method employ a load cell and an accelerometer that are both mounted on a platform upon which the object is situated. A signal from the load cell that is based at least in part on the object being situated on the platform and a signal from the accelerometer that is based at least in part on the object being situated on the platform are combined together to derive a mass of the load. Such combining of the signals may occur via signal processing that may include digital processing and/or analog processing. The load cell and the accelerometer each have an operative direction, and they may be oriented with respect to one another on the platform such that the operative directions are opposite one another. Such a respective orientation of the operative directions enables the two signals to be input to an analog multiplication circuit to derive a weight of the object.

Accordingly, an aspect of the disclosed and claimed concept is to provide an improved weighing apparatus and method that enable the mass of an object to be determined while the weighing apparatus and or the object is in motion.

Another aspect of the disclosed and claimed concept is to provide an improved weighing apparatus and method that employ signals from a load cell and from an accelerometer to derive a weight of an object that is accurate regardless of whether the object is undergoing acceleration apart from acceleration due to gravity.

Other aspects of the disclosed and claimed concept are provided by an improved method of determining a mass of an object while the object is situated on a support that is in motion. The method can be generally stated as including positioning the object on a support that is movable, receiving a first signal representative of a load that is applied to the support due at least in part to the object while the support and the object are in motion, receiving a second signal representative of an acceleration of the support while the support and the object are in motion, and generating a third signal representative of the mass of the object based at least in part upon at least a portion of the first signal and at least a portion of the second signal.

Further aspects of the disclosed and claimed concept are provided by an improved weighing apparatus structured to be installed on a support that is movable and further structured to determine a mass of an object while the object is situated on the support and the object and the support are motion. The weighing apparatus can be generally stated as including a load cell structured to generate a first signal that is representative of a load that is applied to the support which is due at least in part to the object while the support and the object are in motion, an accelerometer structured to generate a second signal representative of an acceleration of the support while the support and the object are in motion, a processing apparatus structured to receive as inputs the first and second signals and further structured to generate as an output a third signal representative of the mass of the object based at least in part upon at least a portion of the first signal being combined with at least a portion of the second signal, and the processing apparatus comprising an analog signal processing apparatus structured to receive as inputs the first and second signals, a digital processing apparatus structured to generate the third signal, and a number of analog-to-digital converters situated electronically between a number of output terminals of the analog signal processing apparatus and a number of input terminals of the digital processing apparatus.

Further aspects of the disclosed and claimed concept are provided by an improved transportation mechanism that can be generally stated as including the aforementioned weighing apparatus and further comprising a movable platform structured to have the object situated thereon, the accelerometer and the load cell being situated on the movable platform.

### BRIEF DESCRIPTION OF THE DRAWINGS

A further understanding of the disclosed and claimed concept can be gained from the following Description when read in conjunction with the accompanying drawings in which:

FIG. 1 is schematic depiction of an improved transportation mechanism that is in accordance with the disclosed and claimed concept and that includes an improved weighing apparatus that is likewise in accordance with the disclosed and claimed concept;

FIG. 2 is a schematic depiction of a first type of processing system of the weighing apparatus;

FIG. 3 is an operational diagram depicting how a load cell and an accelerometer of the weighing apparatus can be arranged such that their operative directions are opposite one another;

FIG. 4 is an operational diagram depicting the load cell and the accelerometer without being subjected to non-gravitational acceleration;

FIG. 5 is an operational diagram depicting the load cell and the accelerometer when subjected to non-gravitational acceleration;

FIG. 6 is a schematic depiction of a second type of processing system of the weighing apparatus;

FIG. 7 is an operational diagram depicting how a load cell and an accelerometer of an alternative weighing apparatus can be arranged such that their operative directions are parallel with one another; and

FIG. 8 is a schematic depiction of a third type of processing system of the weighing apparatus.

### DESCRIPTION

An improved transportation mechanism 4 in accordance with the disclosed and claimed concept is depicted in an exemplary fashion in FIG. 1 as being a forklift. The transportation mechanism 4 includes a chassis 8 and a platform 12, with the platform being situated on the chassis 8. The chassis 8 includes an engine and wheels and thus is movable from place to place. The platform 12 that is situated on the chassis is thus likewise movable along with the other portions of the transportation mechanism, such as in the generally horizontal direction along floors and/or up and down ramps and the like as the chassis is driven from place to place. Additionally, the platform 12 is movable in the vertical direction in order to lift objects above the ground and to elevate them to desired heights for storage, transport, and the like in a known fashion.

The transportation mechanism 4 additionally and advantageously includes a weighing apparatus 16 in accordance with the disclosed and claimed concept. The weighing apparatus 16 includes an accelerometer 20, a load cell 24, and a processing system 28 that are electronically connected together. As is forth in greater detail elsewhere herein, the accelerometer 20 and the load cell 24 provide input signals to the processing system 28, and the processing system 28 provides output responsive thereto.

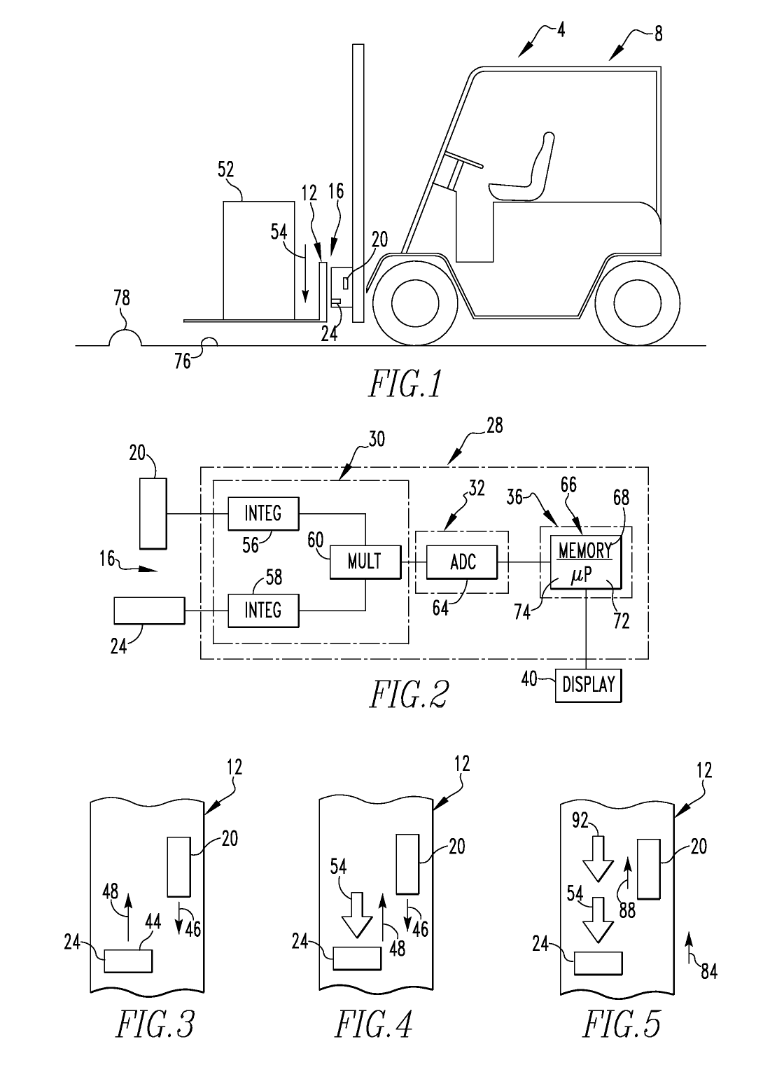

The exemplary weighing apparatus 16 is depicted schematically in FIG. 2. The accelerometer 20 and the load cell 24 are depicted as being connected with the processing system 28, and the processing system 28 is depicted as including an analog processing apparatus 30, a digital conversion apparatus 32, and a digital processing apparatus 36. The digital processing apparatus 36 is depicted as being connected with an output apparatus 40 which can include any of a wide variety of devices such as visual displays, printers, etc., and can also be the inputs to other devices such as data logging devices, computers, and the like without limitation.

The improved weighing apparatus 16 advantageously employs the principle that a mass multiplied by an acceleration equals a force and, similarly, that a force divided by an acceleration equals a mass. In effect, the signal from the load cell 24 is divided by the simultaneously-generated signal from the accelerometer to obtain the mass of an object situated on the load cell 24. As mentioned above, a load cell in isolation typically requires, for accurate weighing, that an object that is situated thereon be static, meaning that it does not experience any non-gravitational acceleration. However, by providing the accelerometer 20 in addition to the load cell 24, and by effectively dividing the signal from the load cell 24 by the corresponding signal from the accelerometer 20, the effects of non-gravitational acceleration on an object situated on the load cell 24 are effectively eliminated. As such, an object situated on the load cell 24 can be weighed and have its mass determined while the transportation mechanism 4 is in motion. In effect, additional loading on the load cell 24 due to non-gravitational acceleration of an object situated thereon is counteracted by the corresponding acceleration signal from the accelerometer 20. This advantageously enables an object situated on the platform 12 to have its mass determined while the transportation mechanism 4 is in motion, i.e., while the platform 12 and the object situated thereon are both in motion.

As can be understood from FIG. 1, the accelerometer 20 and the load cell 24 are both situated on the platform 12 of the transportation mechanism 4, although it is understood that in other embodiments the accelerometer 20 and the load cell 24 could be otherwise situated without departing from the present concept. As the transportation mechanism 4 is driven, for example, along the floor of a warehouse, the vibrations of the platform 12 due to imperfections in the floor of the warehouse, due to the treads on the wheels of the chassis 8, and due to vibrations from the engine and the like are registered essentially simultaneously by the accelerometer 20 and the load cell 24. As will be explained in greater detail below, the simultaneous subjecting of the accelerometer 20 and the load cell 24 with its load thereon to various accelerations enables the accelerations to be effectively canceled, thus resulting in an accurate mass determination regardless of the bumps and other vibrations and accelerations that the platform 12 may experience during movement of the transportation mechanism 4.

As suggested above, some processing of the signals from the accelerometer 20 and the load cell 24 is performed by the analog processing apparatus 30, and other processing is performed by the digital processing apparatus 36. The analog processing apparatus 30 is provided to process the signal prior to the signal being processed by the digital conversion apparatus 32 because known analog-to-digital converters typically do not have sampling rates that are sufficiently fast to accurately characterize the high frequency vibrations that the platform 12 may undergo. As such, it has been determined that certain analog processing of the analog signals from the accelerometer 20 and the load cell 24 is desirable prior to digital sampling, conversion, and processing.

As has been set forth above, the inventive concept operates by effectively dividing the analog force signal from the load cell 24 by the analog acceleration signal from the accelerometer 20. However, while analog multiplication circuits are known to exist, no analog division circuit is known to exist. As such, the invention employs effectively reversing, mirroring, or otherwise manipulating the analog signal from the accelerometer and multiplying it with the analog output from the load cell 24 with the use of an analog multiplication circuit. It is noted that the force signal from the load cell 24 can alternatively or additionally be subjected to reversing, mirroring, etc., or other manipulation without departing from the present concept.

FIG. 3 schematically depicts the accelerometer 20 and the load cell 24 both being situated on the platform 12 and being positioned and oriented with respect to one another such that their respective operative directions 46 and 48 are oriented opposite one another. That is, the accelerometer 20 has an operative direction 46 that is vertically downward, i.e., in the direction of acceleration due to gravity when the transportation mechanism 4 is on a horizontal surface, such that non-gravitational acceleration of the accelerometer 20 in the operative direction 46 is registered on the accelerometer 20 as a positive acceleration and is indicated as a positive voltage that is output therefrom. Acceleration of the accelerometer 20 in the upward direction, i.e., in a direction opposite the operative direction 46, is registered on the accelerometer 20 as a negative acceleration and is indicated by a relatively lower but still positive voltage that is output by the accelerometer 20. Still referring to FIG. 3, it can be seen that the load cell 24 has a loading surface 44 that faces in another operative direction 48, which is the operative direction of the load cell 24. The upward-oriented operative direction 48 of the load cell 24 is effectively the operational direction of acceleration due to gravity. That is, the load cell 24 will register the same load whether an object thereon is accelerated at 9.81 meters per second squared due to gravity or whether the load cell 24 and the same object thereon are (in a non-gravitational environment) accelerated at 9.81 meters per second squared in the operative direction 48.

Notably, the operative direction 48 of the load cell 24 is in a generally upward direction whereas the operative direction 46 of the accelerometer 20 is in a generally downward direction, meaning that the operative directions 46 and 48 are opposite one another. As will be set forth in greater detail below, the arrangement of the accelerometer 20 and the load cell 24 to have opposite operative directions 46 and 48 is an example of a manipulation of the signals from the accelerometer 20 and the load cell 24 that enables such signals to be multiplied with one another to achieve the advantageous cancellation of non-gravitational acceleration.

The accelerometer 20 outputs a positive voltage in the presence of gravitational acceleration. Moreover, when the accelerometer 20 experiences a positive non-gravitational acceleration, which is an acceleration in the direction of the operational direction 46, it outputs an increased voltage. It is reiterated that such a positive acceleration of the accelerometer 20 is in the downward direction when the transportation vehicle 4 is on a horizontal surface. An object that is situated on the platform 12 can be said to at all times be experiencing gravitational acceleration, and the object may periodically experience other accelerations such as the aforementioned acceleration in the direction of the operational direction 46. If the platform 12, along with the accelerometer 20 and the load cell 24 situated thereon, is accelerated vertically downward, such downward acceleration will result in the outputting from the accelerometer 20 of a signal having an increased voltage. At the same time, however, such acceleration of the load cell 24 and any object thereon will be in a direction opposite the operative direction 48 of the load cell 24, resulting in a reduced voltage output from the load cell 24. It can be seen, therefore, that acceleration in such a direction effectively counteracts at least a portion of conventional acceleration of an object due to gravity. As such, an object that is situated on the platform 12 and that is being subjected to acceleration in the downward direction (in addition to gravitational acceleration) effectively weighs less during such downward acceleration, as measured by the load cell 24. That is, the load cell 24 outputs a signal of reduced voltage in such a situation. It is reiterated that the accelerometer 20 outputs an increased voltage signal during such downward acceleration.

As can be understood from FIG. 4, when an object 52 of a given mass is situated on the loading surface 44 of the load cell 24 in the presence of gravity, the object 52 applies to the loading surface 44 a weight 54 that acts on the load cell 24 in a direction opposite its operative direction 48. It can be visualized from FIG. 4, however, that an acceleration of the platform 12 in the vertically downward direction (from the perspective of FIG. 4) will, as set forth above, result in a reduced weight being applied to the loading surface 44 of the load cell 24. Such reduced weight results in an analog signal output from the load cell 24 that is of a reduced voltage. As set forth above, however, such an acceleration in the vertically downward direction from the perspective of FIG. 4 will be registered by the accelerometer 20 in such a fashion that it will result in an analog output signal from the accelerometer 20 that is of an increased voltage. As will be set forth in greater detail below, a reduced voltage value (such as the voltage of the signal from the load cell 24) multiplied by a correspondingly increased voltage value (such as the voltage of the analog signal from the accelerometer 20) effectively results in unity because the corresponding reduced and increased values effectively cancel one another. This principle will be described in greater detail below. Moreover, it is noted that the signals from the accelerometer 20 and the load cell 24 each vary in a linear fashion due to increased or decreased acceleration and weight.

It thus can be seen that the accelerometer 20 and the load cell 24 are oriented and positioned such that changes in their signals due to non-gravitational acceleration correspond with one another and generally counteract one another. While the accelerometer 20 and the load cell 24 are depicted as both being situated on the same structural element of the platform 12, it is understood that variations from such a geometry are possible without departing from the present concept. Furthermore, the weighing apparatus 16 can potentially be provided as a discrete device which can be retrofitted to an existing device such as a forklift, for instance, to convert it into the transportation mechanism 4.

It thus is envisioned that generally any acceleration that is experienced by the platform, whether it be from the vibration of the tire tread of the transportation mechanism 4 as it drives along a floor of a warehouse, whether it is due to the transportation mechanism 4 hitting bumps and the like, or whether it is due to engine vibration, for instance, will be detected by both the accelerometer 20 and the load cell 24. The simultaneous signals from the accelerometer 20 and the load cell 24 can be manipulated in such a fashion, as is set forth herein, that any such non-gravitational acceleration can be effectively canceled and thus advantageously ignored.

It is noted, however, that since the accelerometer 20 and the load cell 24 are themselves effectively mechanical devices, the signals that are output from the accelerometer 20 and the load cell 24 may not precisely coincide with a change in acceleration to the platform 12. Rather, either or both of such signals may be slightly delayed, even to an infinitesimal extent, due to inertia, hysteresis, and other well-known factors. As such, the analog processing apparatus 30 advantageously further includes an acceleration integration circuit 56, a weight integration circuit 58, and a multiplication circuit 60, all of which are analog circuits. The acceleration integration circuit 56 receives the analog signal that is output from the accelerometer 20 and, in an analog fashion using analog circuitry, integrates the signal over a period time, such as on the order 0.5-1.0 seconds or other appropriate duration. The integrated acceleration signal is then input to the multiplication circuit 60. Likewise the weight integration circuit 58 receives the analog output signal from the load cell 24 and integrates it over the same period of time as is used by the acceleration integration circuit 56. The integrated weight signal is then output from the weight integration circuit 58 and is provided as another input to the multiplication circuit 60.

The multiplication circuit 60 is a known analog circuit that multiplies the magnitudes of the voltages of the two inputs, i.e., from the acceleration integration circuit 56 and the weight integration circuit 58, and outputs therefrom an analog signal that is representative of the mass of the object 52. Since the output from the multiplication circuit 60 is based at least in part upon signals from both the accelerometer 20 and the load cell 24, it can be seen that the mass signal that is output by the multiplication circuit 60 is generally representative of the mass of the object 52, regardless of whether the object 52 and the platform 12 are stationary or whether they are both in motion. The mass signal that is output by the multiplication circuit 60 is then provided as an input to an analog-to-digital converter (ADC) 64 of the digital conversion apparatus 32 which converts the analog mass signal (which is in the form of a voltage) into a digital data stream that is representative of digits that are themselves representative of the mass of the object 52.

The digitized mass signal that is output by the ADC 64 is then input into a processor apparatus 66 of the digital processing apparatus 36 for further processing. The processor apparatus 66 includes a microprocessor 68 or other processor and further includes a memory 72 that is operatively connected with the microprocessor 68. The memory 72 has stored therein a number of routines 74 in the form of instructions which, when executed on the microprocessor 68, cause the digital processing apparatus 36 to perform certain predetermined functions.

One of the functions may be, for instance, a calibration operation that is performed by a calibration routine 74 whereby the weighing apparatus 16 is effectively calibrated. One fashion in which this can be done is to detect the signal from the ADC 64 when the transportation mechanism 4 is stationary and the platform is subjected to no non-gravitational acceleration, vibration, or electromagnetic interference (such as might otherwise result from operation of an alternator of the transportation mechanism 4). The output from the ADC 64 is in the form of “counts”, and the calibration routine 74 may first detect the number of “counts” that result from zero load on the platform 12. The platform 12 may then have a known load applied to it, such as 2,000 pounds (i.e., one short ton), and the number of counts from the ADC 64 that correspond with the known load are then detected by the processor apparatus 66. The calibration routine 74 may then perform a manipulation such as a linear approximation to develop a simple algorithm for converting the “counts” from the ADC 64 responsive to any load applied to the platform 12 into the corresponding mass of such load. It is noted, however, that in alternative embodiments a calibration data table having various counts and the corresponding weights may be generated and stored in the memory 72 for retrieval in responses to receiving a number of counts from the ADC 64.

Other routines 74 may be employed on the processor apparatus 66, such as filtering routines 74 and other such routines. One such filtering routine can be a FIR (Finite Impulse Response) filtering routine or other filtering routine. Other filtering such as anti-aliasing filtering can also be done, but this typically is provided by a low pass filter (not expressly depicted herein) that is electronically interposed between the multiplication circuit 60 and the ADC 64. Other types of filtration and other desirable routines for execution by the processor apparatus 66 can be envisioned.

An example of the operation of the transportation mechanism 4 and particularly the weighing apparatus 16 thereof is presented generally in FIG. 5. If the transportation mechanism 4 (as is depicted in FIG. 1) travels along a floor 76, the transportation mechanism 4 may go over a bump 78 in the floor 76, i.e., such as by having the wheels roll over the bump 78. During forward motion of the transportation mechanism 4 toward the bump 78 and prior to engaging the bump 78, it will be assumed that the platform 12 and the object 52 are undergoing no non-gravitational acceleration. Thus, an effect on the weighing apparatus 16 (as depicted generally in FIG. 4) prior to encountering the bump 78 would include a gravitational load due to the object 52 that is equal to the weight 54 and that is applied in the vertically downward direction on the loading surface 44 of the load cell 24. Since at this point it is assumed that no non-gravitational acceleration is being applied, the accelerometer 20 generates an output that is representative of zero non-gravitational acceleration. As will be set forth in greater detail below, this signal from the accelerometer 20 is an analog signal having a positive non-zero voltage. Furthermore, the load cell 24 generates an analog output having a voltage that is representative of the weight 54.

When the transportation mechanism 4 strikes the bump 78, which is depicted herein as being a protrusion that extends vertically above the exemplary generally horizontal and planar surface of the floor 76, the platform 12 and thus the object 52 will be accelerated in the vertically upward direction, as is indicated at the numeral 84 in FIG. 5. Such acceleration 84 as a result of engaging the bump 78 is correspondingly experienced by the accelerometer 20, which experiences acceleration in the vertically upward direction as is indicated generally at the numeral 88. Since such acceleration 88 is in a direction opposite the operative direction 46, the accelerometer 20 will responsively output an analog signal having a relatively reduced but still positive non-zero voltage that is representative of a negative non-gravitational acceleration. Simultaneously (or substantially so), the load cell 24 is likewise accelerated in the vertically upward direction as a result of the bump 78, and the object 52 situated on the load cell 24 is resultantly also accelerated in the vertically upward direction, with such non-gravitational acceleration being in the operative direction 48 of the load cell 24. This causes the object 52 to apply not only its gravitational load 54 to the load cell 24 but to further apply an additional load 92 to the load cell 24. Such additional load 92 is a force that results from the load cell 24 engaging the object 52 and accelerating it in the operative direction 48, i.e., applying to the object 52 acceleration in the operative direction 48 that is in excess of gravitational acceleration.

The additional load 92 is applied to the loading surface 44 of the load cell 24 in a direction opposite the operative direction 48 and amounts to a relatively greater load on the load cell 24, which results in an analog output from the load cell 24 that is of a correspondingly increased voltage. The increased voltage analog signal that is output by the load cell 24 (and integrated by the weight integration circuit 58) in response to the bump 78 is multiplied with the lesser but still positive voltage analog signal that is output by the accelerometer 20 (and integrated by the acceleration integration circuit 56) in response to the bump 78. Such multiplication is performed by the multiplication circuit 60, and the result is a combined signal is of the same magnitude as a mass signal that would be generated by the multiplication circuit 60 when only the gravitational load, i.e., the weight 54, is applied to the weighing apparatus 16. It thus can be seen that by providing the accelerometer 20 and the load cell 24 with operative directions 46 and 48, respectively, that are manipulated to be opposite one another, the analog signals that are output from the accelerometer 20 and the load cell 24 effectively cancel out any non-gravitational acceleration when the two signals are multiplied. This advantageously enables the weighing apparatus 16 to accurately determine the mass of the object 52 while the object 52 and the platform 12 (and the transportation mechanism 4) are all in motion.

From the foregoing, it can be understood that the weighing apparatus 16 is configured such that any non-gravitational acceleration of the platform 12 and the object 52 will be effectively canceled, thereby resulting in an accurate determination of the mass of the object 52 at all times. As such, vibrations due to the engine of the transportation mechanism 4, vibrations due to the transportation mechanism 4 being driven across an uneven surface, and acceleration due to, for instance, the platform being lifted or lowered, and other sources of acceleration and vibration, are effectively canceled from affecting the determination of the mass of the object 52. The weighing apparatus 16 thus outputs an accurate mass of the object 52 without the need to stop movement of the transportation mechanism 4, which save time and cost.

As mentioned above, the accelerometer 20 outputs a non-zero voltage regardless of the non-gravitational acceleration to which the accelerometer 20 is subjected. In the depicted exemplary embodiment, the accelerometer 20 provides an analog output having a voltage of 1.65 volts at zero non-gravitational acceleration, meaning that it output 1.65 volts in the presence of gravitational acceleration regardless of the direction in which the operative direction 46 of the accelerometer 20 is pointed. In response to a positive acceleration of 1 G, the voltage may increase to 3.3 volts (i.e., an increase of 1.5 volts for an increase in acceleration of +1 G in the operative direction). Still similarly, the accelerometer 20 may output an analog signal having a voltage of 0.15 volts (i.e., a decrease by 1.5 volts) when the accelerometer 20 is subjected to −1 G. Within its operational range the accelerometer 20 always outputs a positive voltage. In this regard, it is noted that bumps and the like that may cause the accelerometer 20 experience acceleration outside its operational range will typically be of at most only a relatively short duration, and it is further noted that the weighing apparatus 16 will be capable of outputting a mass of the object 52 immediately prior to and immediately subsequent to the accelerometer 20 being outside its operational range. The accelerometer 20 can be provided with other specifications, operating and voltage ranges, and the like depending upon the needs of the particular environment.

A method of determining a mass of an object 52 that is situated on the platform 12 while the platform 12 and the object 52 are in motion might begin with the positioning of the object 52 on the platform 12. The method may also include receiving a first signal that is representative of the load while the support 12 and the object 52 are in motion, and receiving a second signal representative of an acceleration while the platform 12 and the object 52 are in motion. A third signal can then be generated that is representative of the mass of the object 52 and that is based at least in part upon at least a portion of the first signal and at least a portion of the second signal. Other operations such as integration, analog-to-digital conversion, filtering, and so forth can also be employed. The various signals that are employed in the weighing apparatus can be processed using any number of well understood analog and digital circuits and devices.

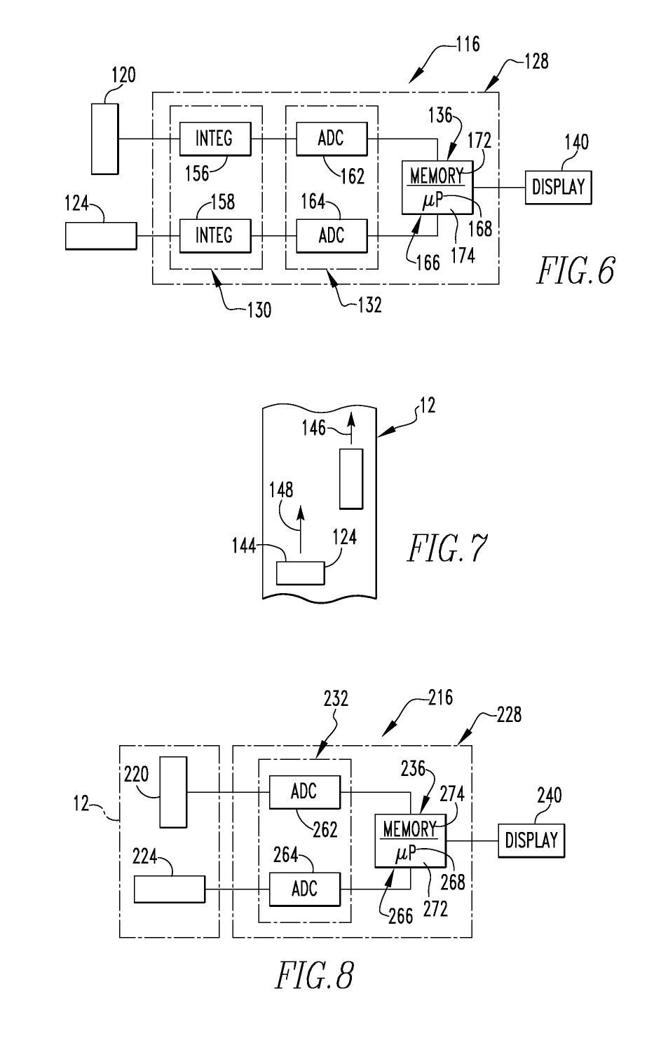

An alternative weighing apparatus 116 that is employable with the transportation mechanism 4 is depicted schematically in FIG. 6. The weighing apparatus 116 has many of the same components as the weighing apparatus 16, except that the signal processing operations and equipment are slightly different.

The weighing apparatus 116 includes an accelerometer 120 and a load cell 124 that have operative directions 146 and 148, respectively, that are depicted in FIG. 7 as being pointed in the same direction, i.e., being parallel with one another. The operative directions 146 and 148 can be in the same direction since, as will be set forth in greater detail below, a digital division algorithm can be employed to effectively divide the signal from the load cell 124 by the signal from the accelerometer 120. If it is preferred to instead employ a digital multiplication algorithm, the operative directions 146 and 148 would be opposite one another, such as is the case with the operative directions 46 and 48.

The accelerometer 120 and the load cell 124 generate analog signals and output them to a processing system 128. The processing system 128 includes an analog processing apparatus 130, a digital conversion apparatus 132, and a digital processing apparatus 136. The processing system 128 outputs to an output apparatus such as a display 140 a signal that is representative of a mass of an object that has been placed on a loading surface 144 of the load cell 124, and the mass can be accurately determined while the object is in motion, as set forth above.

The analog processing apparatus 130 includes an acceleration integration circuit 156 that integrates the analog output from the accelerometer 120 and outputs an analog integrated acceleration signal. The analog processing apparatus 130 further includes a weight integration circuit 158 that integrates the analog signal from the load cell 124 and outputs an analog integrated weight signal. Again, the acceleration integration circuit 156 and the weight integration circuit 158 both integrate the analog signal that is input thereto over the same, i.e., an equal, predetermined period.

The digital conversion apparatus 132 includes an ADC 162 that converts the analog output from the acceleration integration circuit 156 into a digitized representation thereof. The digital conversion apparatus 132 further includes another ADC 164 that converts the analog signal from the weight integration circuit 158 into a digitized representation thereof. The two digital signals that are output from the ADC 162 and the ADC 164 are then input to a processor apparatus 166 which has stored in a memory 172 thereof a number of routines 174 that are executable on a processor 168. One such routine 174 is a division routine 174 which divides the weight-derived signal from the ADC 164 by the acceleration-derived signal from the ADC 162 to calculate a mass for the object that was placed on the loading surface 144. Other routines 174 include calibration routines, filtering routines, and the like can be employed without limitation.

As suggested above, if the processor 166 relies upon a multiplication algorithm routine 174 rather than the aforementioned division routine 174, the accelerometer 120 could be repositioned so that its operative direction 146 is opposite the operative direction 148 of the load cell 124. It is noted, however, that the operative directions 146 and 148 need not be opposite one another if the multiplication routine includes instructions that convert an increased load signal into a reduced load signal and vice versa or that convert and increased acceleration signal into a reduced acceleration signal and vice versa, by way of example. The use of a division routine is possible because such division is being performed by the processor apparatus 166, which is digital, rather than on an analog processing circuit. Such division is possible because the signals that originate with the accelerometer 120 and the load cell 124 are digitized by the ADC 162 and the ADC 164 prior to such division.

An improved weighing apparatus 216 in accordance with another embodiment of the disclosed and claimed concept is depicted generally in FIG. 8 and is usable on the transportation vehicle 4. The weighing apparatus 216 is depicted in FIG. 8 as including an accelerometer 220 and a load cell 224 that are depicted as being mounted to the platform 12 and as being electrically connected with a processing system 228. The processing system 228 includes a digital conversion apparatus 232 and a digital processing apparatus 236. The digital conversion apparatus 232 includes an analog-to-digital converter 262 that converts the analog acceleration signal from the accelerometer 220 into a digitized version thereof and another analog-to-digital converter 264 that converts the analog signal from the load cell 224 into a digitized version thereof. In the instant exemplary embodiment, the analog-to-digital converters 262 and 264 have a sampling rate and an accuracy that are sufficiently high that they can accurately convert analog signals from the accelerometer 220 and load cell 224 into true digital versions thereof.

The analog-to-digital converters 262 and 264 provide their digitized acceleration and weight signals as data streams to the digital processing apparatus 236 which includes a processor apparatus 266 having a microprocessor 268 and a memory 272 having various routines 274 stored therein for execution on the microprocessor 268. The routines 274 can be similar to the other routines 74 and 174 set forth above and may include integration routines, division routines, multiplication routines, filtering routines, and the like without limitation. The routines 274 are executable on the microprocessor 268 to cause the processor apparatus 262 combine via division or multiplication, for example, the digitized acceleration and load signals from the analog-to-digital converters 262 and 264 into a mass signal that is representative of the mass of the object 52. The mass signal is then output to a display 240 or other appropriate output device.

The weighing apparatus 216 is mountable on the platform 12 in the same fashion as the weighing apparatuses 16 and 116 to enable the transportation mechanism 4 to accurately output a mass value for the object 52 when the object 52, the platform 12, and/or the transportation mechanism 4 are in motion. The weighing apparatus 216 potentially can be more accurate and less costly than the weighing apparatuses 16 and 116 since the weighing apparatus 216 employs fewer analog devices and rather performs a greater amount of processing operations with the processor apparatus 266.

It thus can be seen that an improved system is provided wherein the mass of an object can be accurately determined even while the object is in motion on the transportation mechanism. While the exemplary transportation mechanism 4 described herein has been a forklift, it is understood that the teachings herein are widely applicable to numerous other applications. For example, loading system that automatically lift trash cans, raise them to a dumping height, and then dump the contents into a receptacle can apply the teachings to a movable platform on which the trash cans are disposed and which lifts such trash cans. Since the mass of the trash can be determined while the trash can is being lifted to the dumping height, the dumping operation is much faster since it does not require the system to stop or otherwise become stationary in mid-lift in order to determine an accurate mass. Other applications of the teachings herein will be apparent to one of ordinary skill in the art.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A method of determining a mass of an object while the object is situated on a support that is in motion, the method comprising:
positioning the object on a support that is movable;
receiving a first signal representative of a load that is applied to the support due at least in part to the object while the support and the object are in motion;
receiving a second signal representative of an acceleration of the support while the support and the object are in motion; and
generating a third signal representative of the mass of the object based at least in part upon at least a portion of the first signal and at least a portion of the second signal.

2. The method of claim 1, further comprising receiving as the second signal an analog signal whose voltage decreases while remaining positive in response to an increase in the acceleration.

3. The method of claim 2, further comprising generating the third signal based at least in part upon multiplying together at least a portion of the first signal and at least a portion of the second signal.

4. The method of claim 1, further comprising:
determining the mass of the object at least in part from the third signal and at least one of a lookup table and an algorithm; and
outputting a value for the mass.

5. The method of claim 1, further comprising:
generating a fourth signal based at least in part upon an integration of the first signal over a period of time;
generating a fifth signal based at least in part upon an integration of the second signal over the period of time; and
generating the third signal based at least in part upon at least a portion of the fourth signal and at least a portion of the fifth signal.

6. The method of claim 5, further comprising:
generating a digitized fourth signal based at least in part upon an output from an analog-to-digital converter to which the fourth signal is input;
generating a digitized fifth signal based at least in part upon an output from another analog-to-digital converter to which the fifth signal is input; and
generating the third signal based at least in part upon at least a portion of the digitized fourth signal being combined with at least a portion of the digitized fifth signal.

7. The method of claim 6, further comprising generating the third signal based at least in part upon at least a portion of the digitized fourth signal being one of multiplied with and divided by at least a portion of the digitized fifth signal.

8. The method of claim 5, further comprising generating the third signal based at least in part upon at least a portion of the fourth signal being multiplied with at least a portion of the fifth signal.

9. The method of claim 1, further comprising:
obtaining a normalized signal based at least in part upon at least a portion of the first signal being combined with at least a portion of the second signal; and
generating the third signal further based at least in part upon an output from an analog-to-digital converter to which the normalized signal is input.

10. The method of claim 9, further comprising obtaining the normalized signal based at least in part upon at least a portion of the first signal being multiplied with at least a portion of the second signal.

11. The method of claim 10, further comprising obtaining as the normalized signal a signal that is based at least in part upon an output from an electronic multiplication circuit to which the first and second signals are input.

12. The method of claim 10, further comprising generating the third signal further based at least in part upon a subjecting of the output from the analog-to-digital converter to one or more filtering algorithms.

13. The method of claim 1, further comprising:
generating a digitized first signal based at least in part upon an output from an analog-to-digital converter to which the first signal is input;
generating a digitized second signal based at least in part upon an output from another analog-to-digital converter to which the second signal is input; and
generating the third signal based at least in part upon at least a portion of the digitized first signal being combined with at least a portion of the digitized second signal.

14. A weighing apparatus being structured to be installed on a support that is movable and being further structured to determine a mass of an object while the object is situated on the support and the object and the support are motion, the weighing apparatus comprising:
a load cell structured to generate a first signal that is representative of a load that is applied to the support which is due at least in part to the object while the support and the object are in motion;
an accelerometer structured to generate a second signal representative of an acceleration of the support while the support and the object are in motion;
a processing apparatus structured to receive as inputs the first and second signals and further structured to generate as an output a third signal representative of the mass of the object based at least in part upon at least a portion of the first signal being combined with at least a portion of the second signal; and
the processing apparatus comprising an analog signal processing apparatus structured to receive as inputs the first and second signals, a digital processing apparatus structured to generate the third signal, and a number of analog-to-digital converters situated electronically between a number of output terminals of the analog signal processing apparatus and a number of input terminals of the digital processing apparatus.

15. The weighing apparatus of claim 14 wherein the analog signal processing apparatus comprises an electronic multiplication circuit that is structured to generate a normalized signal based at least in part upon at least a portion of the first signal being multiplied with at least a portion of the second signal.

16. The weighing apparatus of claim 14 wherein the accelerometer is structured to output an analog signal whose voltage decreases while remaining positive in response to an increase in the acceleration.

17. The weighing apparatus of claim 16 wherein the accelerometer has an operative direction whereby the accelerometer outputs a signal representative of a positive acceleration responsive to the accelerometer being subjected to non-gravitational positive acceleration in the operative direction, and wherein the load cell has a loading surface that faces toward another operative direction whereby the load cell outputs a signal representative of a positive weight responsive to the loading surface having loading applied thereto in the another operative direction, the accelerometer and the load cell being oriented with respect to one another such that the operative direction and the another operative direction are substantially opposite one another.

18. A transportation mechanism comprising the weighing apparatus of claim 14, and further comprising a movable platform structured to have the object situated thereon, the accelerometer and the load cell being situated on the movable platform.

19. The transportation mechanism of claim 17, wherein the transportation mechanism further comprises a lifting mechanism that comprises the platform, the lifting mechanism being structured for lifting residential waste or other containers and dumping them into a garbage truck or other receptacle.

20. The transportation mechanism of claim 17, wherein the transportation mechanism further comprises a lifting mechanism that comprises the platform, the lifting mechanism being a front end loader device that is structured for lifting dumpsters or other containers and dumping them into garbage trucks or other receptacles.
